(19) United States
(12) Patent Application Publication
(10) Pub. No.: US 2017/0212997 A1
(43) Pub. Date: Jul. 27, 2017

(54) AUTOMATED MODELING AND INSURANCE RECOMMENDATION METHOD AND SYSTEM

(71) Applicants: James BUONFIGLIO, Cold Spring Harbor, NY (US); Thomas LUNA, Smithtown, NY (US); Peter CHASE, Huntington, NY (US)

(72) Inventors: James BUONFIGLIO, Cold Spring Harbor, NY (US); Thomas LUNA, Smithtown, NY (US); Peter CHASE, Huntington, NY (US)

(21) Appl. No.: 15/366,581

(22) Filed: Dec. 1, 2016

Related U.S. Application Data
(60) Provisional application No. 62/261,517, filed on Dec. 1, 2015.

(51) Int. Cl. G06F 19/00; G06Q 10/06

(52) U.S. Cl. CPC G06F 19/328; G06F 19/324; G06Q 10/06393; G06F 19/3406

(57) ABSTRACT

A scenario modeling engine that generates an enhanced insurance feature recommendation for a group of insured entities or employees is disclosed. The scenario modeling engine may aggregate demographic data regarding the insured entities, receive a user response indicating at least one insurance goal for the group regarding an insurance feature, generate an insurance feature score or profile according to the insurance goal and the received demographic data; generate a first insurance feature recommendation based on the profile; receive industry benchmark data for the insurance feature and report the first insurance feature recommendation compared with the industry benchmark; receive user input indicating revision for the insurance feature; and report a set of insurance features or an insurance plan based on the revision for the insurance feature. A bid or solicitation for a bid for an insurance policy may be automatically sent accordingly.

### CROSS-REFERENCE TO RELATED APPLICATION

The present non-provisional patent application claims the benefit of priority from U.S. Provisional Patent Application No. 62/261,517, filed Dec. 1, 2015, the entire contents of which are incorporated herein by reference.

### FIELD OF THE INVENTION

The present invention is related to the field of scenario modeling and automated insurance-related recommendation processing.

### BACKGROUND OF THE DISCLOSURE

Insurance decisions are often made based on partial information about various available options and are sometimes made based on anecdotal evidence. Individuals and businesses often find choosing insurance plans perplexing and onerous and find it difficult to evaluate the relative merits of specific options offered by insurers. Further, there is often a lack of transparency as to the value added by the insurance broker.

Employee benefit information, for example in a health insurance context, is often difficult to procure and to analyze. Employers often find it difficult to obtain real time recommendations based on their actual employee demographic data and risk profiles, or such recommendations often rest on guess work on the part of the broker as to the employer's goals and preferences. Often, insurance underwriting is delayed because of information that is conveyed to an intermediary in one format, which has to be reformatted or reentered and provided to an insurance company, but employers often lack specific information about the real value based on actuarial data and actual cost of various benefit features that are available, and alternatives thereto.

The employer or other insurance client often needs to trust that an insurance broker is showing them every relevant deal available and is not unduly influenced by compensation, bonuses and the like that may be received by the broker from an insurer. The client is forced to rely on the insurance broker's expertise, industry-specific experience and understanding to achieve client goals and to meet client risk tolerances for recommendations. Also, the client's decision making process may be hampered by the client's lack of access to planning and modeling that allows real time information as to the value, cost and industry benchmarks for options available with respect to each major insurance feature or criterion.

### SUMMARY OF THE DISCLOSURE

Described herein is a device, system, method and means for providing such a device, system, and method, as well as a non-transitory computer-readable medium comprising a program of the instructions for providing a method as outlined herein. Such a scenario modeling engine may gather demographic data for insured entities from one or more sources, receive a user response via a user interface indicating at least one insurance goal for the group comprising the insured entities, and provide a recommendation for the insurance feature based on an insurance benefit numeric score or profile determined according to the user response indicating the at least one insurance goal. Also, industry benchmark data may be used to provide feedback to the user regarding the insurance feature, and the insurance feature value may thus be revised by the user. The benchmark data may include industry average, median or mode data, may include industry maximum or minimum data, and may include such data from past years, a most recent year for which data are available, or from a current year. A set of insurance features determined in such a way may then be provided in a bid or in a solicitation for a bid.

A data-driven scenario modeling engine may be configured to generate at least one insurance feature recommendation for a group comprising a set of insured entities, the scenario modeling engine including:

an input user interface configured to receive a user response indicating at least one insurance goal for the group;

a demographic data inputer configured to receive demographic data regarding the set of insured entities; an insurance benefit profile generator configured to generate an insurance benefit profile based on the indicated insurance goal and the received demographic data; and

a user interface generator configured to report the at least one insurance feature recommendation for the group based on the generated insurance benefit profile.

Such a scenario modeling engine may further include an insurance plan analyzer configured to receive at least one of an insurance plan and a benefit set of the group, wherein the insurance benefit profile is based on the received at least one of the insurance plan and the benefit set of the group.

Such a scenario modeling engine may further include a benchmark comparator configured to generate a relevant group benchmark for the at least one insurance feature recommendation based on relevant group data retrieved for the insurance feature, wherein the user interface generator is configured to report the generated relevant group benchmark for the at least one insurance feature recommendation.

In such a scenario modeling engine with benchmark comparator, the relevant group benchmark is based on an industry of the group.

In such a scenario modeling engine with benchmark comparator, the relevant group benchmark is based on a geographic area of the group.

In such a scenario modeling engine with benchmark comparator, the relevant group benchmark is based on a size of the group.

In such a scenario modeling engine, the user interface generator may be configured to provide an estimate of at least one of a cost and a value of the at least one insurance feature, and to report in real time a re-estimated cost or value in response to user adjustment of an aspect of the at least one insurance feature.

In such a scenario modeling engine, the set of insured entities may include people employed by the group, and the at least one insurance feature may include an insurance benefit for an entity of the set of entities.

In such a scenario modeling engine, the modeling engine may further include a bid controller configured to submit at least one of a bid and a solicitation for a bid for an insurance plan containing the at least one insurance feature to a marketplace or a carrier.

In such a scenario modeling engine of claim 1, the user interface generator may be configured to provide an indication of a percentage or a quantity associated with a user input feature, and to facilitate user input for changing the percentage or the quantity associated with the plan underwriting factor. For example, the user interface generator may be configured to provide a user input feature configured to facilitate user submission of a plan to a carrier in accordance with the changed percentage or quantity.

In such a scenario modeling engine, the user interface generator may be configured to provide user input feature configured to facilitate the user's submission of a plan to a carrier. The set of insured entities may be self-insured entities.

In such a scenario modeling engine, the user interface generator may be configured to provide at least one of a contribution amount and a contribution percentage corresponding to a contribution under an insurance plan comprising an insurance feature comprised in the at least one insurance feature recommendation, and to report in real time a re-estimated cost or value of the insurance plan in response to user adjustment of the least one of the contribution amount and the contribution percentage. The contribution may be a contribution by an insured entity of the set of insured entities.

Also, the contribution may be a contribution by a subset of insured entities of the set of insured entities, the subset of insured entities comprising insured entities within a salary range.

The user interface generator may be configured to provide options under an insurance plan comprising an insurance feature contained in the at least one insurance feature recommendation, the options being available to be chosen by insured entities of the set of insured entities, and to receive an input indicating an election of a choice of the options.

The user interface generator may provide a quote for an insurance plan for the group in response to a request received from the group, the insurance plan comprising an insurance feature contained in the insurance feature recommendation. Also, the user interface generator may provide a portal to facilitate communication between the group and an originator of the quote.

Also described is a data-driven scenario modeling engine that is configured to generate an enhanced insurance feature recommendation for a group including a set of insured entities, the scenario modeling engine including:

a demographic data aggregator configured to receive demographic data regarding the set of insured entities;

a user interface configured to receive a user response indicating at least one insurance goal for the group regarding at least one insurance feature;

an insurance benefit profile generator configured to generate an insurance feature profile based on the indicated insurance goal and the received demographic data;

a recommendation generator configured to generate a first insurance feature recommendation based on the insurance benefit profile;

an industry benchmark data collector configured to receive industry benchmark data for the at least one insurance feature;

a benchmark-based enhancer engine configured to report the first insurance feature recommendation compared with the industry benchmark data for the at least one insurance feature;

the benchmark-based enhancer engine configured to receive a user input indicating revision for the at least one insurance feature; and

the benchmark-based enhancer engine configured to report a set of insurance features based on the revision for the at least one insurance feature.

Such a scenario modeling engine may include an insurance plan data collector and analyzer configured to receive at least one of an insurance plan and an insurance feature set of the group, and to determine the insurance feature profile based on the at least one of the received at least one of the insurance plan and the insurance feature set of the group.

In such a scenario modeling engine, the industry benchmark data may be based only on an industry of the group, or the industry benchmark data may be based on a geographic area of the group, or the industry benchmark data may be based on a size of the group, or a combination of one or more of the foregoing.

In such a scenario modeling, the benchmark-based enhancer engine may be configured to provide an estimate of at least one of a cost and a value of the at least one insurance feature, and to report in real time a re-estimated cost or value in response to the user revision of the at least one insurance feature.

In such a scenario modeling engine, the benchmark-based enhancer engine may be configured at least one of automatically to solicit a bid and automatically to provide a bid based on the set of insurance features reported.

In such a scenario modeling engine, the demographic data aggregator may be configured to receive the demographic data from an employee census.

Such a scenario modeling engine may further include a group limit data receiving module configured to input limit data for the group, wherein the insurance benefit profile generator may be configured constrain the first insurance feature recommendation according to the limit data, and the benchmark-based enhancer engine is configured to constrain the set of insurance features according to the limit data.

Other features and advantages of the present invention will become apparent from the following description of the invention which refers to the accompanying drawings.

### BRIEF DESCRIPTION OF THE FIGURES

FIG. 1 illustrates a dashboard provided by a graphical user interface containing information about claims paid, according to an aspect of the present disclosure.

FIGS. 2 and 3 illustrate input that a user may be prompted to provide to answer a question about the group's goals, insurance philosophy, employee profile, risk tolerance or the like, according to an aspect of the present disclosure.

FIG. 4 illustrates a recommendation or goals shown by a graphical user interface based on the user input previously provided, according to an aspect of the present disclosure.

FIG. 5 illustrates benchmarking of insurance features, including medical, dental and the like, and the percentage of employers that offer such benefits, according to an aspect of the present disclosure.

FIG. 6 illustrates benchmarking within the medical benefit section according to an aspect of the present disclosure.

FIG. 7 illustrates various copay options as benchmarked for the medical plan, according to an aspect of the present disclosure.

FIG. 8A illustrates employee demographic information, according to an aspect of the present disclosure.

FIG. 8B illustrates demographic aggregate information for short term disability plans, according to an aspect of the present disclosure.

FIGS. 9-10A illustrate that another assumption may be made for “pool charges” for the insurance feature and that when underwriting factors are changed, different plan outcomes may be produced, according to an aspect of the present disclosure.

FIG. 11 is a “slider” of a graphical user interface allowing users to change the visualization for the insurance feature and to obtain revised benchmark information in real time, according to an aspect of the present disclosure.

FIG. 12 shows the slider information of the graphical user interface revised according to user input, according to an aspect of the present disclosure.

FIG. 13 illustrates a contribution modeling tool providing user feedback, according to an aspect of the present disclosure.

FIG. 14 illustrates that the contribution may be modeled to allow the user to try employee contributions in real time, using the lighter slider to the desired percentage or amount, according to an aspect of the present disclosure.

FIG. 15 illustrates contribution level for the highest and lowest bid employees and the salary brackets, according to an aspect of the present disclosure.

FIG. 16 illustrates that the contribution level for the highest or lowest paid employees can be linked with census or other employee demographic data and that the aggregate about each employee class can be provided, according to an aspect of the present disclosure.

FIG. 17 illustrates an example of a scenario modeling engine and its components, according to an aspect of the present disclosure.

FIG. 18 illustrates an example of a system showing the scenario modeling engine and its logical relation to other components, according to an aspect of the present disclosure.

FIGS. 19 and 20 provide an overview of process flows, according to an aspect of the present disclosure.

FIGS. 21-26B illustrate a graphical user interface provided to an insurer or carrier to provide an overview of insurance accounts won or lost, according to an aspect of the present disclosure.

### DETAILED DESCRIPTION OF THE EMBODIMENTS

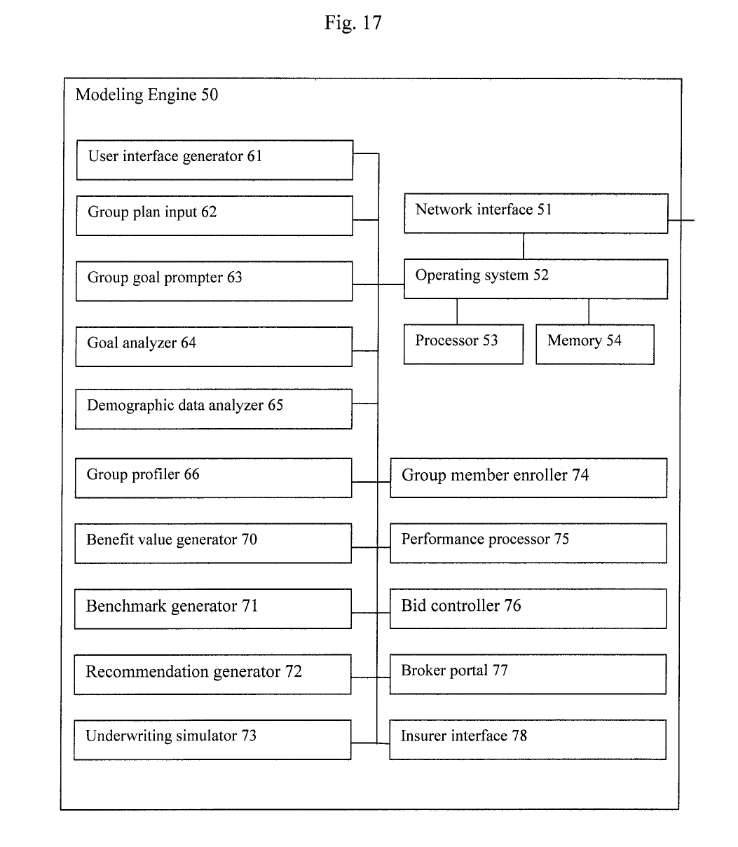

A modeling engine 50 as illustrated in FIG. 17 may provide a transparent marketplace for employers or insured groups and other participants. An employer may find it easier to make informed decisions as to what features to opt for in an insurance plan or policy because the value of the feature and alternatives to that feature and their values may be provided in real time. Also, based on questions designed to elicit the goals and risk tolerance and the like, recommendations can be made for insurance. Insurers can also have direct access to employers or other groups and the role of the insurance broker may be limited or eliminated.

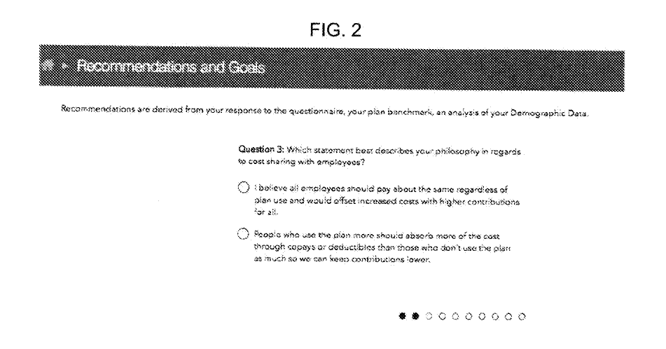

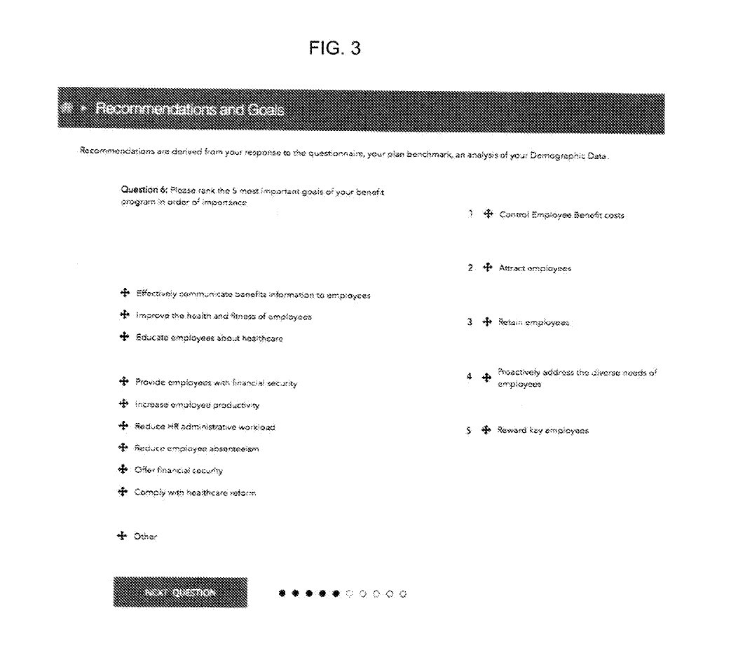

FIGS. 2 and 3 show questions that an employer may be prompted to answer so that the system obtains an understanding of the employer's goals, insurance philosophy or approach, employee profile and risk tolerance. While described sometimes herein as an “employer,” it will be understood that other collections of insured entities, such as a group, unit or other organization interested in obtaining insurance for their members, clients or employees and are also contemplated. The term employer is used only by way of example. While examples provided herein sometimes refer to employee benefits or health insurance, it will be understood that many other types of insurance, as well as non-insurance planning and modeling are also contemplated.

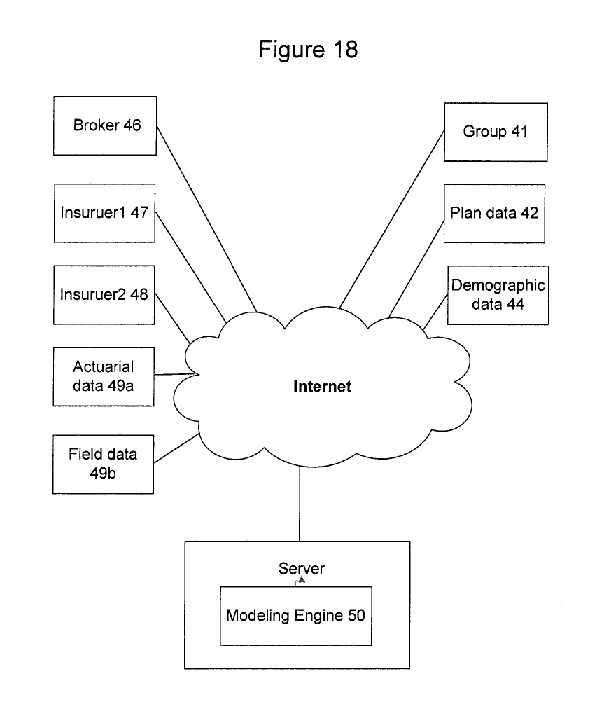

FIG. 18 illustrates that group 41 may connect via the Internet to a server that includes modeling engine 50. For example, group 41 may be a company or a firm that is interested in obtaining health insurance for its employees. However, modeling engine 50 may be implemented as software that resides on a local processor in house at group 41. Similarly, modeling engine 50 may be software that is run or resides at broker 46, insurer one 47 or at some central location. Modeling engine 50 includes user interface generator 61 that may provide an interface for a user at group 41 that provides the graphical interface that provides these questions. Group goal prompter 63 can provide appropriate questions via user interface generator 61 to such a user. The answers provided by user may be processed by goal analyzer 64 of modeling engine 50.

The group plan input 62 of modeling engine 50, as illustrated in FIG. 17, then processes the data retrieved. The group's answers may be matched with a database of answers and a value or a score may be assigned.

A flexible system that need not rely on adherence to a single standard for the purposes of electronically transmitting bids including cost information or product features, is provided.

This method allows insurance carriers and other vendors whose products are sold through the system to innovate freely as they are not tied into an electronic structure that cannot accommodate variation. Further, accepting this variation from one vendor, will not require every other vendor to adhere to a new standard.

The methodology may use a multi-dimensional matrix that can grow as needed to fully describe a product. The matrix consists of any number of insurance product features. Each product feature or insurance feature can have any number of attributes. A feature can be fully described by at least one attribute but may also require more than one attribute or combination of attributes.

A matrix can encompass the features of an insurance product and may be thought of as a three-dimensional array having a length specifying features, a width specifying attributes, and a depth, specifying elements. For example, a product may be an insurance product such as long term disability insurance or medical insurance.

A product may have one or more features specified by the three-dimensional array. Each feature can have one or more attributes, or if the feature has only one attribute, the attribute may be called an entry. If the feature has more than one attribute, each attribute may have a unique name. For example:

### Product: Long Term Disability Insurance

Feature: Duration (How long a payment will continue if someone is disabled)
   Attribute(Entry): “Until age 65”
   Attribute(Entry): “5 years”

Since The Duration feature has only one attribute it may be called an entry. The codified or allowed entries for the duration attribute are set by marketplace vendors based on their products. These are “Until Age 65” and “5 years” in this example.
Feature: Definition of disability
   Attribute(Entry): “Totally disabled”
   Attribute(Entry): “Unable to perform material duties of own occupation”
   Attribute: “Unable to perform material duties of any occupation”
Feature: Monthly Maximum payment
   Attribute: “$5,000”
   Attribute: “$20,000”

### Coverage: Medical

Feature: physical therapy (this feature will have more than 1 attribute in this example)
   Attributes: Copay—codified options for copay may be $5, $10, $12.50 etc, but not 5 dollars or 5 or $5.00
   Attribute: Limit—codified options for limit may be “40 visits per calendar year” or “40 visits per calendar year combined with occupational therapy and speech therapy” but not “40 visits” etc.
   Attribute: Deductible—codified options may be $100, $200, etc.
   Attribute: Coinsurance—codified options may be 60%, 70%, etc.

One vendor may report “Copay” and “Limit” attributes while another vendor may report only “Deductible” and “Limit” attributes. The system may be flexible to allow for either or other combinations as needed,

More attributes for physical therapy may be added if innovation or change occurs for some vendors in the market. For example: Insurance Carrier A decides to allow “visit forgiveness” as follows: the carrier does not count three physical therapy visits toward the 40 visit maximum if the visits follow the covered individual's participation in a 5k race. We can accommodate this innovation by adding an attribute “Visit Forgiveness” (that no other carrier needs to report) and codify allowed entries as “3 visits following 5k race participation”. As competing carriers in the market evolve, they may add this attribute to their physical therapy feature. Their version may require additional allowed entries in which case we would codify another response as needed. For example: Imagine a competing vendor giving three visit forgiveness for participation in only a 3k race! While all of these features may be reported by a carrier, there is no requirement for them to do so, especially if there product does not have a particular feature or attribute.

### Elements Examples

As described above, combinations of features or attributes can be grouped as elements. Consider the Long term disability plan features and attributes above. We could group the following attributes together and label them the “Disability Gap” element:

### Attribute: Duration: Until age 65

Attribute: Definition of disability: “Unable to perform material duties of own occupation”
Attribute: Monthly Maximum Payment: >$15,000 (or some other calculation such as >59% of the average of key employees' monthly earnings)
This particular element may receive the following scores from table B:

### Element: Disability Gap

### Category: Demographic

### Characteristic: Appeal to Key Employees

### Score: 9

### Element: Disability Gap

### Category: Demographic

Characteristic: Appeal to lower paid employees

### Score: 2

### Element: Disability Gap

### Category: Philosophical

### Characteristic: Corporate Reputation

### Score: 8

For purposes of illustration, different demographic segments may be impacted differently by various benefit elements. “Key employees” are higher earners and may tend to be impacted to a much larger degree by the disability gap element. That is, a low maximum may not impact lower paid employees since they do not “cap out at the maximum” and they still receive a reasonable percentage of their pre-disability earnings, should they become disabled. Also, such lower paid employees may not have special skills or training for providing a disability definition that provides them with protection for inability to work in their “own occupation” instead of in “any occupation” may not matter as much. However, this element may be quite important for “key employees” who are higher earners. For example, disability payments may comprise only 30-40% of their earnings because of the low maximum. Therefore, this attribute or element would get a higher score for them.

Features and their attributes can be passed electronically and described using any number of variables the carrier desires. The system can accept input in many combinations of features and attributes and display bids and comparisons in a consistent format which allows system users to make valid comparisons of product options available to them.

An insurance carrier or vendor can add a feature to a product which will be added to the matrix. Attributes are also added to the feature and marketplace options are codified for each attribute based on variation in feature descriptions from vendors that include that feature in the marketplace. However, each vendor may be able to communicate electronically with only those features and attributes their product possess or for which they are capable of implementing into their electronic communication. There is no requirement to communicate every feature or every attribute. In this way, vendors may be free to innovate, change their products, add or change features and the matrix can accommodate the change and display features and options to purchasers in the marketplace.

Each feature or combination of features and attributes is grouped into a category present in the recommendation engine. Scores are then added for their characteristics and these features and products then become part of the system recommendations.

In the vendor bid portal, our system may allow for a bidder to view the bids provided by other competitors. They can configure the system to automatically adjust their bid in response to competitive bids up to predetermined thresholds. For example, if bidder A reduces their price to X, bidder B can automatically reduce their cost to x−1% up to a minimum price of Y.

The system may elicit answer to a list of questions or otherwise receive user input regarding group goals and the like. These goals can be analyzed as belonging to one or more categories. For example, Table A below contains a list of example categories and example characteristics associated with each of the categories.

TABLE A

| Example Category | Example Characteristics |
|---|---|
| Financial | Cost within budget, rate of inflation controlled, level of risk is |
| | tolerable |
| Demographic | Varying needs of employees based on age/generation, gender, |
| | dependent status, income level, readiness to retire |
| Communication | Paper based, electronic based, face to face, |
| | Communicate and provide education about benefit options |
| | available to employees |
| Competition | plans are affordable for their employees, plans comparable with |
| | other employers in their industry or geographic area, plans |
| | effective in limiting employee turnover |
| Compliance | Documentation complies with relevant legislation, plans |
| | operated using best practices, Potential fine exposure |
| Administration | Risk minimized through sound administrative practices, efficient |
| | process reduces cost |
| Philosophical | User pays more that non user of services, all participants pay |
| | same regardless of use |

Answers and other input regarding the goals, needs and preferences of the group, group attitudes or philosophical approach toward insurance or risk and the like, existing plan information and employee demographic information may be scored. Also, a diagnostic may be administered to determine to what extent a user's goals are being addressed or met by the group's existing plan and how well the existing plan aligns with the goals and philosophical managerial approach of the group. The diagnostic may also determine red flags or operational methods that are not conducive to, or do not align with, best practices in the industry and the diagnostic may identify or highlight one or more gaps.

Each element or insurance feature may be assigned a numeric score relative to its ability to impact a particular category or characteristic. A single element or insurance feature may influence a number of categories or characteristics. Table B illustrates how the factor a high deductible health care plan may impact a variety of categories, where 1-2 mean a low impact, 4-6 mean a median impact, 7-8 mean a high impact, and 9 or 10 very high impact.

TABLE B

| Element | Category | Characteristic | Score |
|---|---|---|---|
| High deductible | Financial | Inflationary | 8 |
| health care plan | | control | |
| | Financial | cost | 8 |
| | Demographic | Appeal to | 5 |
| | | millennial | |
| | | generation | |
| | Demographic | Appeal to lower | 2 |
| | | paid population | |
| | Competition | At benchmark | 7, 5, 2 (score |
| | | | depends on |
| | | | industry/ |
| | | | geography) |
| | Communication | Level of | 8 |
| | | sophistication | |
| | | required to | |
| | | communicate | |
| | | effectively | |
| | Philosophical | User pays more | 8 |
| | | than non-user | |

In addition, scores that are assigned may be weighted by how many categories the element impacts, or how many goals the element or feature help to achieve and the relevant importance of the goal, as gleamed from the user response. The recommendations may be viewed in the user interface by category, score, weighted score, unweighted score, and the like.

The gap analysis can produce a set of elements or features that are not currently present in the current plan but may have a positive impact on the goals or philosophical managerial approach or the like expressed for the group. The diagnostic can match the features or elements of the current plan with those of a catalog of such features or elements. The current plan can be analyzed for characteristics or categories, such as type of plan, for example, medical or dental, long term disability, and the like, specific plan provisions, for example, deductible, salary replacement percentage, or the like, contributions (firm employer or employee), census demographics, costs, and projected inflationary trends.

Products, features, services or strategies or tactics that are not present in the current plan but whose scores are high may appear on a list of recommendations along with the impact that implementing such recommendations may have toward achieving a stated goal, to reaching a desired state or to exhibit a desired characteristic aligned with the philosophical approach. For example, products that the user can express a preference for may include a high deductible health insurance plan that experiences lower rates of inflation or a long term disability plan with lower employer costs and higher salary replacement percentages for employees. A service that may be purchased may be a COBRA administration service or a human resources information system. A strategy or tactic that may be implemented may include an employee contribution strategy that guarantees a fixed budget or a communication tactic that ensures compliance with aspects of the Affordable Care Act (ACA).

User does not complete the questionnaire or otherwise provide responses or preferences or goals, a set of recommendations may still be provided using a client profile assigned by the system based on, for example, the group's industry, geographic location, demographic information for the group, best practices for an industry or nationally, and the like. Products and services recommended by the system may be purchased from the marketplace, as described below. Modeling tools, as discussed below, can be used to measure to impact of strategies and tactics with respect to the impact on achieving the desired state.

User may also be prompted to provide, or the system automatically retrieve or have access to, demographic information that is retrieved by demographical analyzer 55 of modeling engine 50. For example, such demographic information may be stored in a separate demographic data server 44 of a facility of the group or employer and retrieved as needed by modeling engine 50 via the Internet, or demographic data 44 may be stored in some other location and provide in other ways. Also, a current or other insurance plan or key information thereof may be provided or may be automatically obtained by modeling engine 50. For example, such plan data 42 may be provided on a server at a facility of the group or at a separate server or may be otherwise obtained by modeling engine 50.

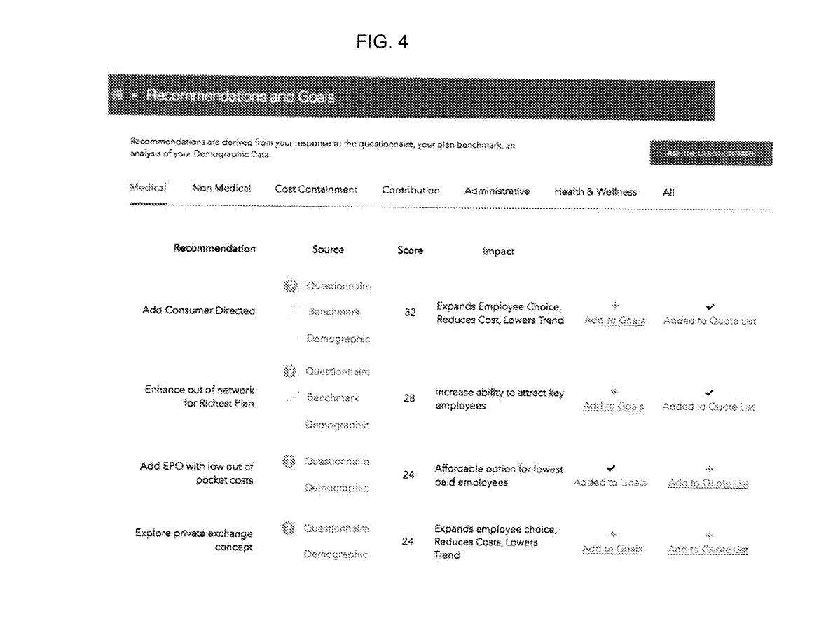

A score may be assigned for the recommendation based on the group's planned design compared with industry benchmarks that may be obtained from a field database 49b that includes industry data. Based on this information, group profiler 66 of modeling engine 50 may create a profile for the group and provide recommendations for client review, as illustrated in FIG. 4. According to an aspect of the disclosure, such scores or the client profile may be provided to the insurance marketplace or to insurance companies or to brokers so as to encourage the best or top recommendations based on the knowledge of the group's goals, preferences, group demographics and current plan.

Benchmark generator 71 of modeling engine 50 illustrated in FIG. 17 can show the user how the group's current plan, or a plan that is being contemplated and presented on screen, compares with those of peers. The benchmarks may be provided according to peers, who may be peers by industry, by geographical area, by size of group, organization or firm, by another such field, by a combination of the foregoing, or just by the global average. The benchmark data may also, or in the alternative, be set by an insurer to indicate industry targets for the feature or industry recommendations for the feature. Benchmark data may be automatically collected from one or more publicly available databases or servers, may be collected from a private or proprietary database, or a combination of the foregoing.

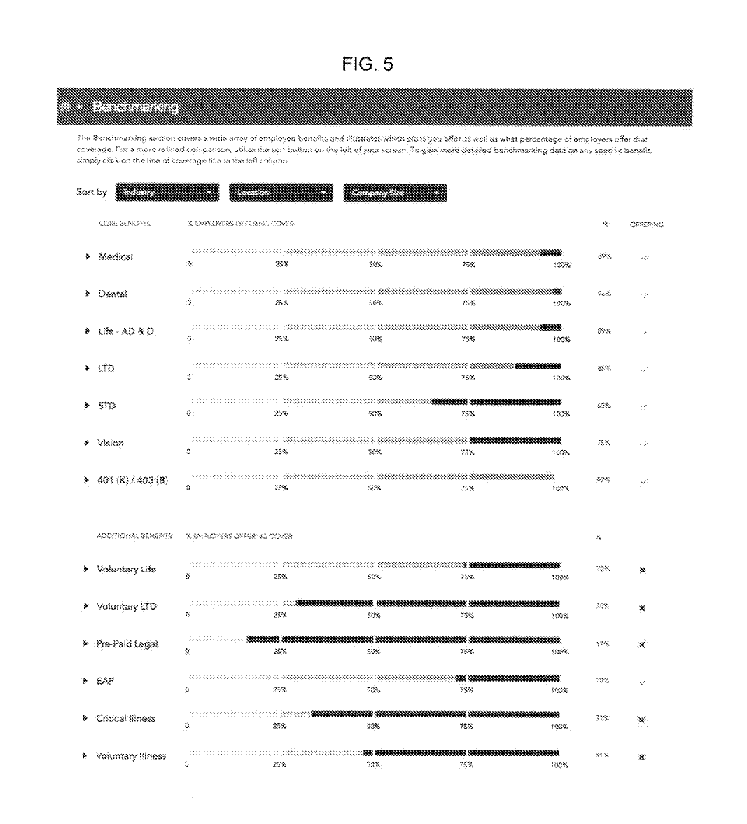

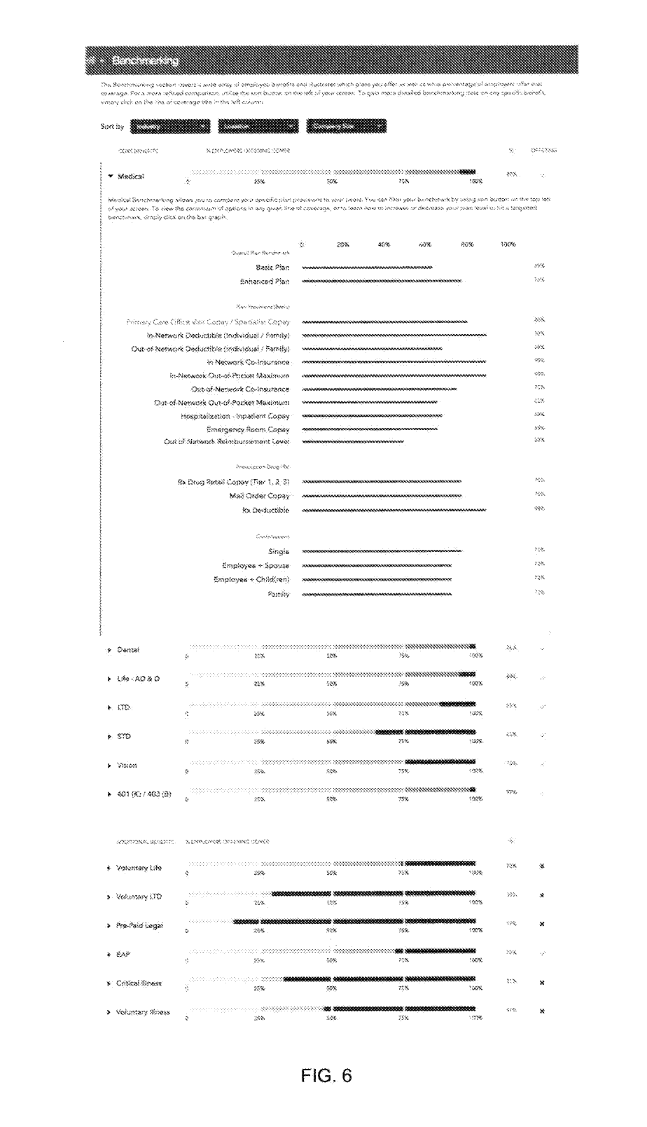

The benchmarking feature allows clients to compare a plan according to design cost and contribution data to a very granular level in real time. FIG. 5, for example, illustrates a list of the benefits, including medical, dental and the like, and the percentage of employers that offer such benefits. FIG. 6 illustrates that within the medical benefit section, what percentage of employers or firms offer various benefits.

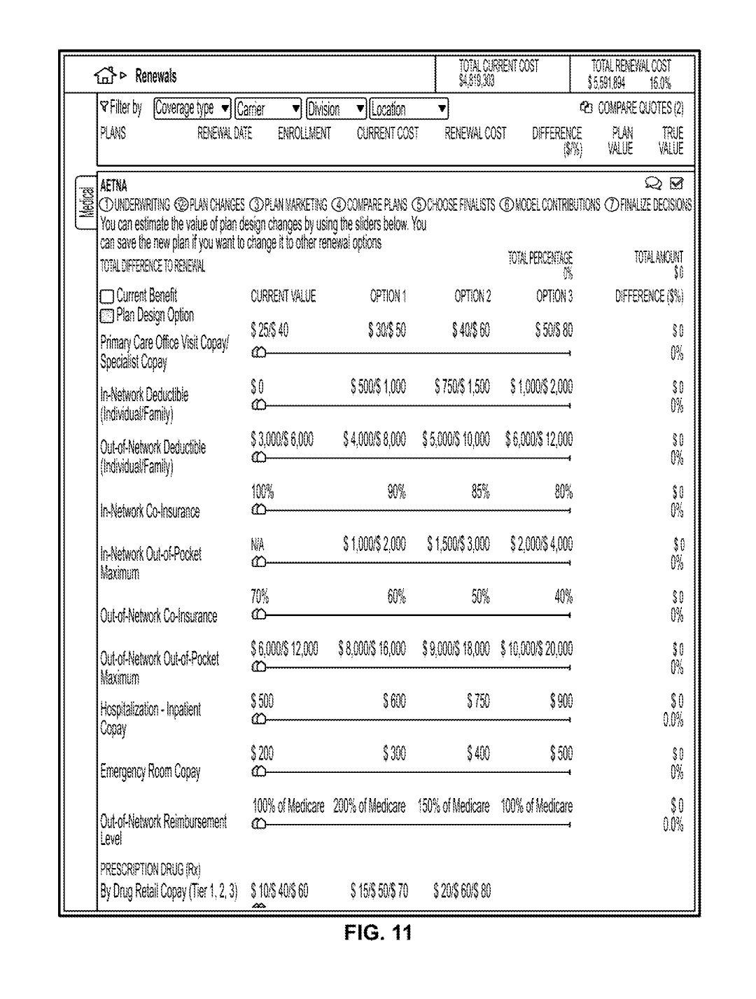

As illustrated in FIG. 11, a slider may be provided to allow the clients to change the visualization feature and see how the changes affect the benchmark in real time. For example, if a client is contemplating an insurance plan that includes a $30.00 copay for a specialist visit, which is benchmarked at the 85^{th} percentile, and then wishes to change the copay to $40.00 or to $50.00 for the specialist copay, the result will be immediately apparent and the benchmark will drop from 85^{th} to 70^{th} and to 50^{th} percentile, according to the above-described adjustments.

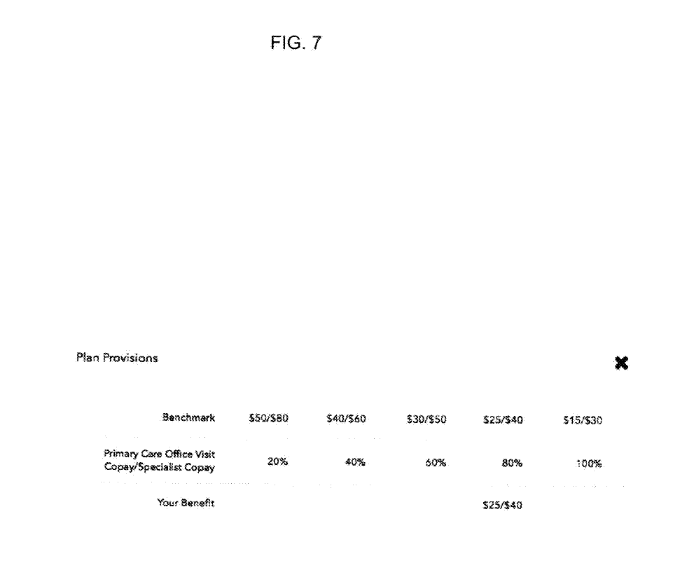

FIG. 6 shows that any particular benefit may be selected and the specific benchmark plan will be shown. This may be particularly valuable for an employer interested in learning about how competitive the plan they contemplate is in the marketplace. This may be important for attracting and retaining employees. FIG. 7 illustrates more detailed information for the specific feature selected in FIG. 6. In particular, FIG. 7 illustrates the various copay options as benchmarked.

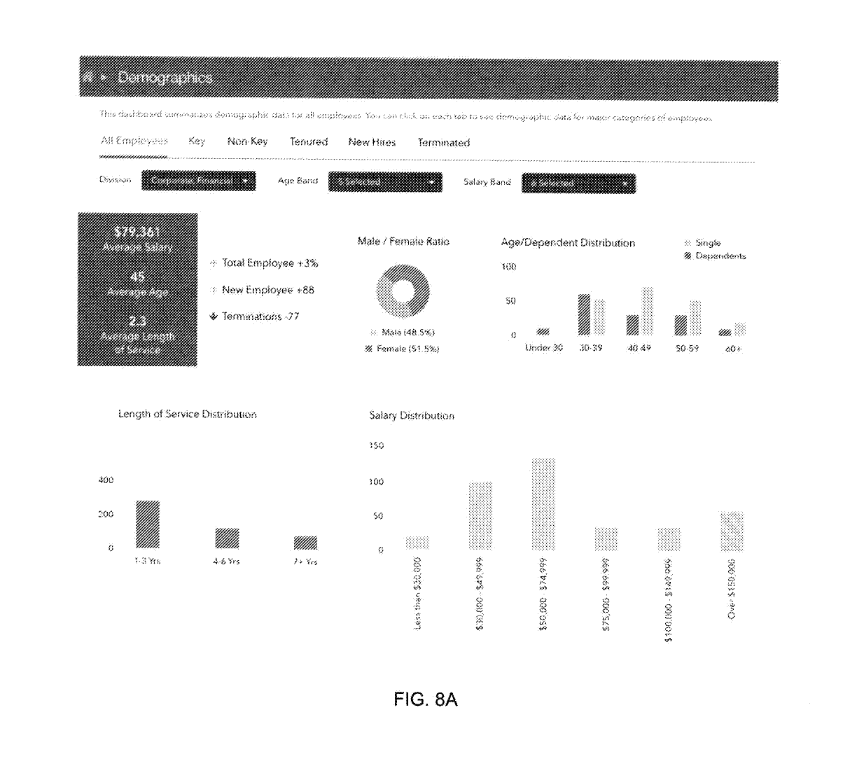

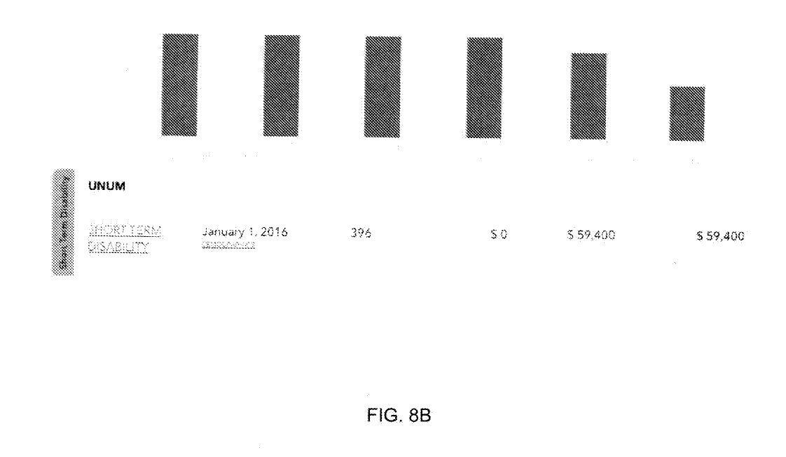

Demographic data analyzer 65 provides the group with real time data derived from an employee census or the like and the current plan. As shown in FIG. 8A, demographic information is viewable by age, salary, number of dependents, length of service, and other such demographic factors and can help the group make informed decisions about how potential changes for any plan design or plan features and/or contributions may impact various segments of the employee population. Further, such analysis may be sorted by employer division, employee salary band, or age band, according to the data for all employees, key employees, new hires, terminated employees, separated employees, and other such groupings. The modeling engine may provide the employer, based on such information, with recommendations and insights. For example, FIG. 8B illustrates that user may select the demographics of long term disability plan and learn that employees earning $150,000.00 or more were receiving only a 40% benefit for their long term disability coverage, instead of the 60% coverage offered to all employees since the plan design contains $5,000.00 monthly covered salary maximum. Such a gap can thus be revealed to the user. Potential gaps may also be shown in the demographic analysis section so as to facilitate understanding of potential insurance plan or policy disadvantages and gaps.

FIG. 17 also illustrates that modeling engine 50 includes an underwriting simulator 73 that allows a group or a broker to view an interactive renewal module that depicts the logic behind the carrier renewal offer. Sliders, or other such graphical interface features or the like, may allow the user, for example, at the group or the broker, the flexibility to model a possible renewal scenario in real time.

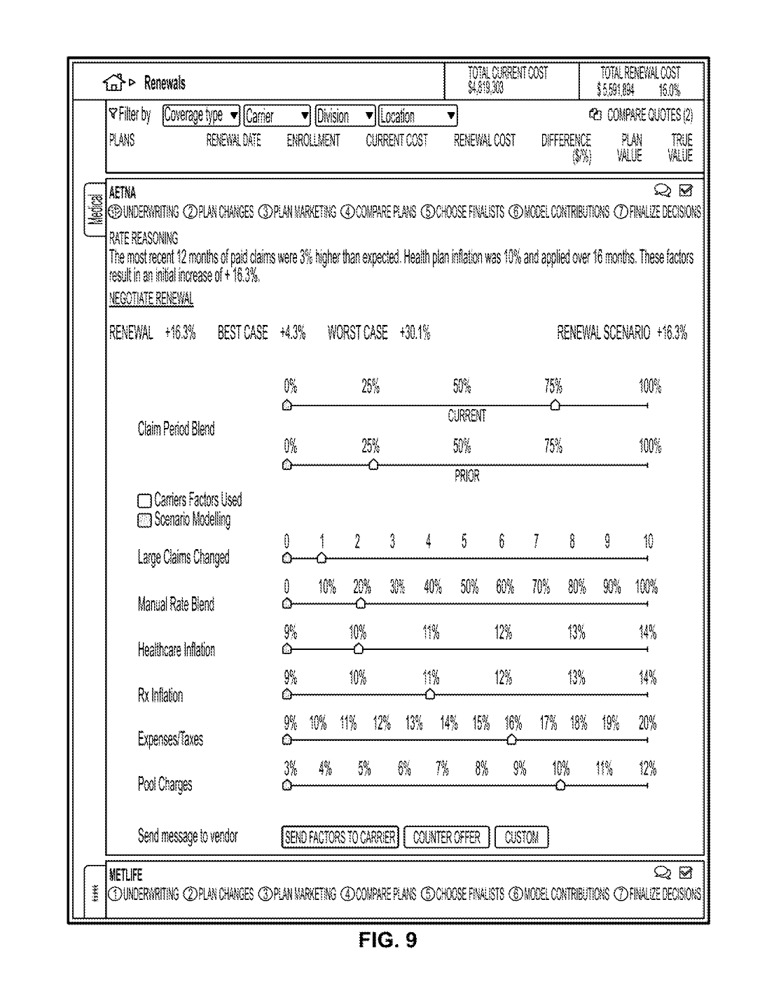

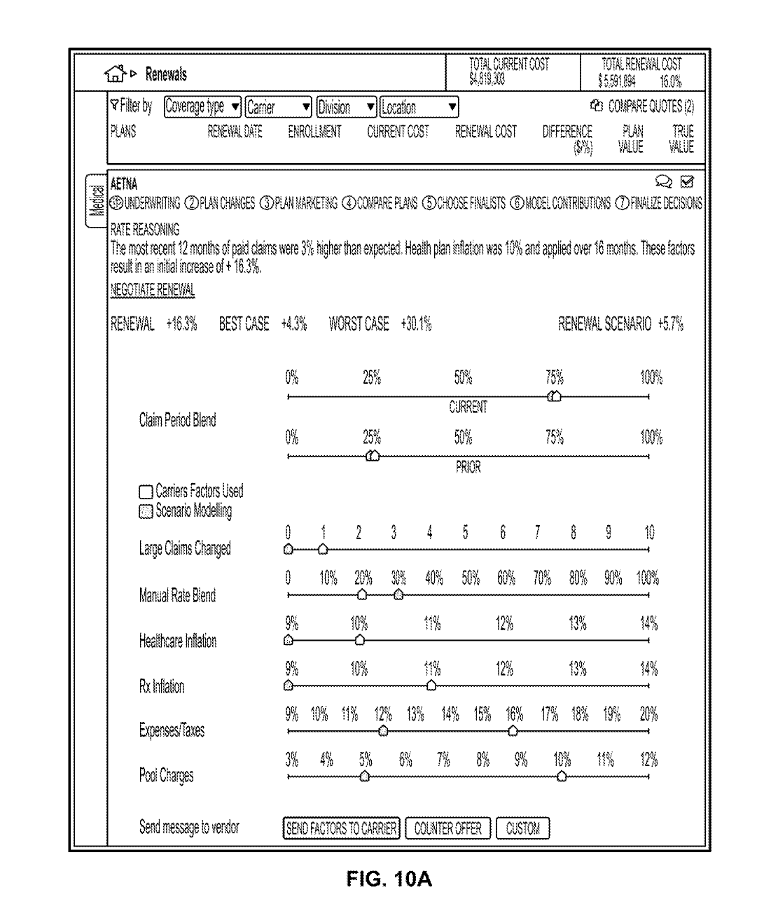

As illustrated in FIG. 9, an initial renewal offer may be shown, including the best and worst case scenarios, at the top of the page based on the underwriting of a group's specific claims data applied against industry ranges of insurance factors and fees. Information about the range of industry norms for specific line items may be provided, including various types of claims. FIG. 9 illustrates the factors used in the renewal with the darker slider (a triangle for each line). It will be understood that instead of, or in addition to, sliders, other ways may be provided to allow user input to adjust displayed items. As illustrated in FIG. 10A, the user can drag the lighter slider, or provide some other type of input to accomplish the adjustment, and the system will provide a scenario model according to the lighter slider movement. According to the adjustment, the underwriting engine will re-underwrite the renewal based on the combination of changes.

Thus, the tool allows for many different renewal scenarios that the employer or broker or the like can model in real time, and each such model can be sent back to the insurer in real time to negotiate the renewal terms. As illustrated in FIG. 9, the employer or group may be empowered to model underwriting. For example, the employer or group may wish to see how costs may change if the number of large claims change for the relevant period. By changing the assumptions on which the policy is underwritten, the costs of the plan may thus be varied. As further illustrated in FIGS. 9-10A, another assumption that may be changed in proposing a plan is the “pool charges” feature. Pool charges are often used to even out the insurance premium by pooling all claims over a certain amount. As illustrated in FIG. 10A, when such underwriting factors are changed, different plan outcome may be produced. The group or employer may thus be empowered to model various plan factors that have a bearing on the cost of the plan to be underwritten.

As illustrated in FIG. 10A, by selecting the “send factors to carrier” button near the bottom of the screen, user is brought to a page that allows interaction with the insurer page or is automatically returned pricing information from the insurer or from an existing database. Based on the results returned to the user, the user can further adjust the model if necessary or desired.

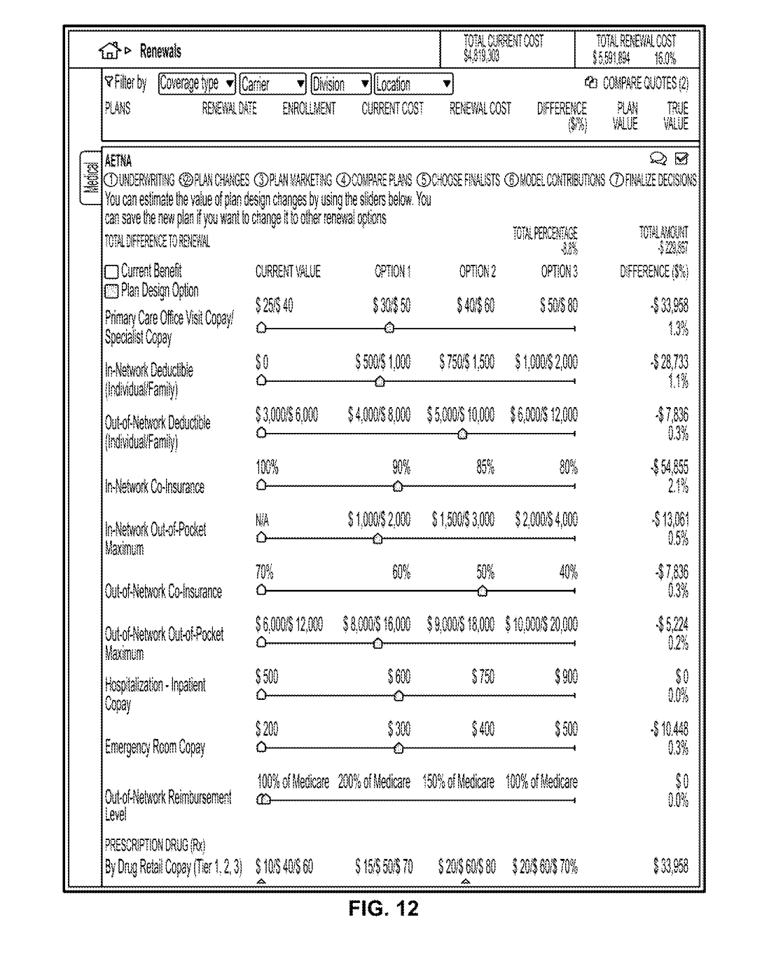

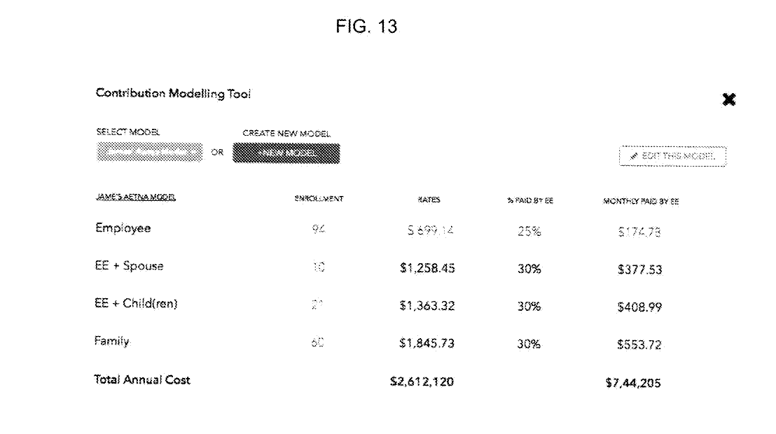

Various attributes or features of the plan contemplated by a user can be adjusted and real cost information may be provided in real time, according to an aspect of the present disclosure as illustrated in FIG. 11. Sliders or other such graphic user interface features may be used, and based on actuarial information and formulas, received either from insurers or based on actuarial database information, such cost information can be viewed. For example, FIG. 18 illustrates actuarial data 49, which may be a stand-alone external database accessed via the Internet, or may be integrated as part of the server or bank of servers that include modeling engine 50. FIG. 11 illustrates some exemplary characteristics of a planned design that may be modifiable by a user. Impact of the pricing may also be provided from an insurer. The darker slider buttons, or other such graphical interface elements, may be used to represent an employer's or group current plans. The lighter slider button, or other such graphical interface elements, may be used to drag current settings to alternative plan design settings, as illustrated in FIG. 12. The actuarial modeling could then be used to provide real time pricing variances, which may be highlighted in their right column.

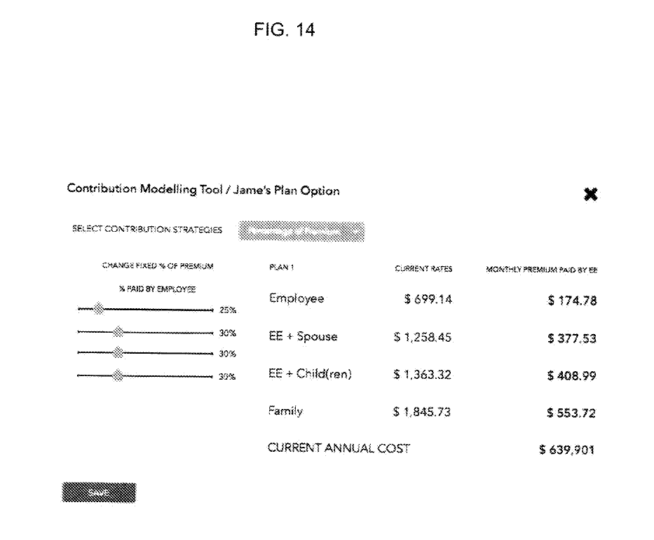

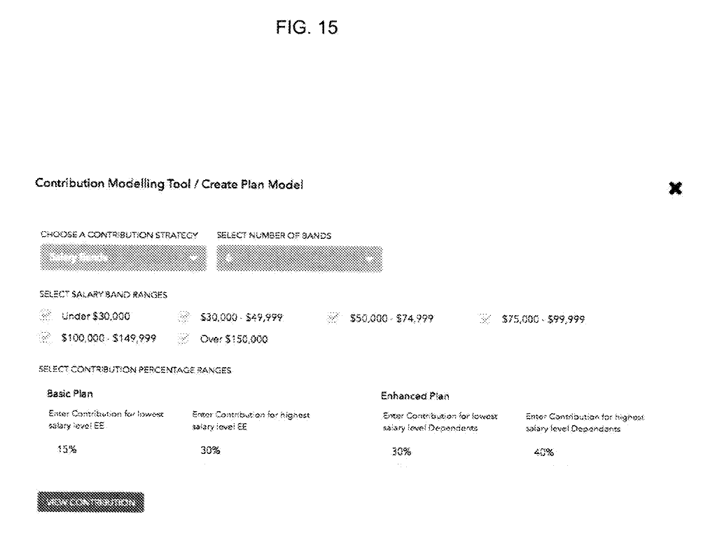

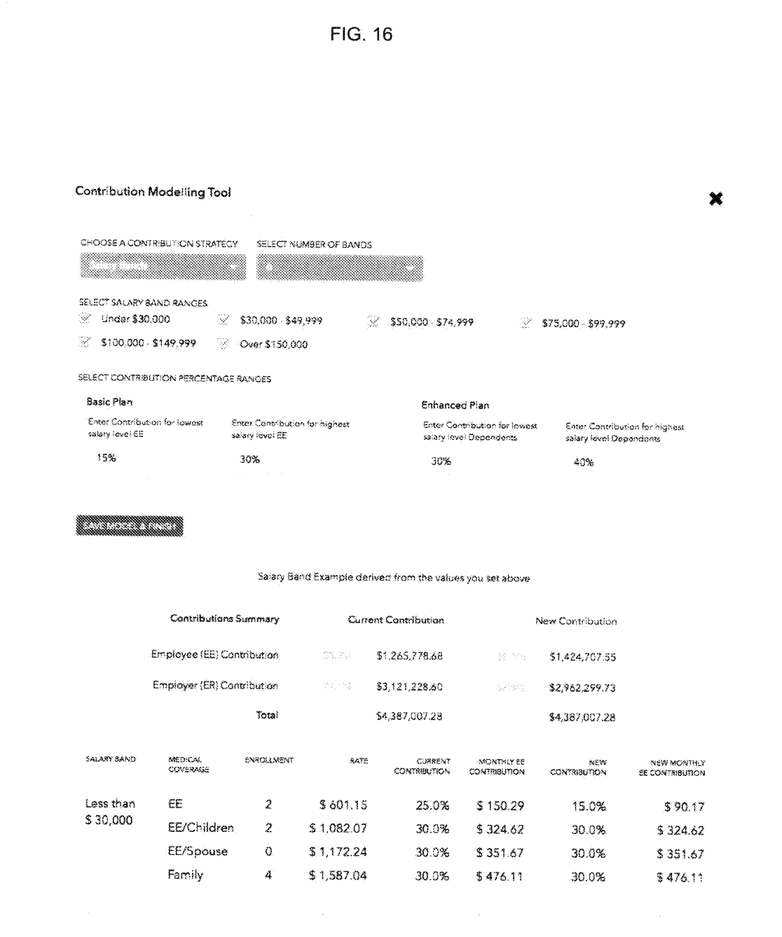

Also, users, for example, group administrators, may be able to see bids without broker screening and potential broker bias, while insurers may be able to negotiate directly with clients or potential clients (that is, for example, groups or employers) through an online communication portal house in the system. As illustrated in FIG. 18, insurer1 47 and insurer2 48 may be accessed via Internet by the server housing modeling engine 50 and/or may be accessed by group 41. As illustrated in FIG. 14, the contribution may be modeled to allow the user to model employee contributions in real time. Using the lighter slider, or other similar graphical interface element, the user, for example, the group benefit administrator, the group, slides or adjusts the slider to the desired percentage or amount, and all individual and aggregate employee and employer costs may be calculated and illustrated. Employers may also model contributions using different strategies, for example, a group may wish to see salary based contributions. This system also allows the group to model contributions utilizing various strategies. For example, the user may wish to see salary based contributions. To accomplish this, the user selects the salary bracket, as illustrated in FIG. 15, and the contribution level for the highest and lowest paid employees, the system can link with the census data or employee demographic data, and perform the calculations and the aggregate by each specific employee class, as illustrated in FIG. 16. Users can run virtually unlimited numbers of scenarios in real time and work to determine an appropriate contribution strategy and level for the group or organization.

According to a further aspect of the disclosure, a user can customize key performance indicators that the user would like on a dashboard or a homepage. For example, groups are often concerned about renewal increases. Such renewal increases, in turn, are often based in part upon the number or value of insurance claims for the preceding period.

An employee portal of modeling engine 50 may also be provided to allow employees, or members of the group, to enroll in a plan, to express preferences for a plan, to provide information about plan choices or plan features available for employees, together with their costs and the like, to make requests or recommendations for options, such as plan features, for employees, Such information may be stored for each employee and reviewed at a later time. The employer could then be updated about the cost associated with enrollment, the number of enrollees, the number of employees not enrolled in any given moment or the like. Such information can also be passed, for example, electronically, to each insurance carrier or service vendor, as needed. Enrollment data may also be used to generate forms that employers or groups are required to submit to various authorities, including the federal government, for example, to comply with the Affordable Care Act. The employee may also be requested to file insurance claims, or have the option of filing claims, or to indicate through employee portal the filing of a claim elsewhere, such as directly to the carrier.

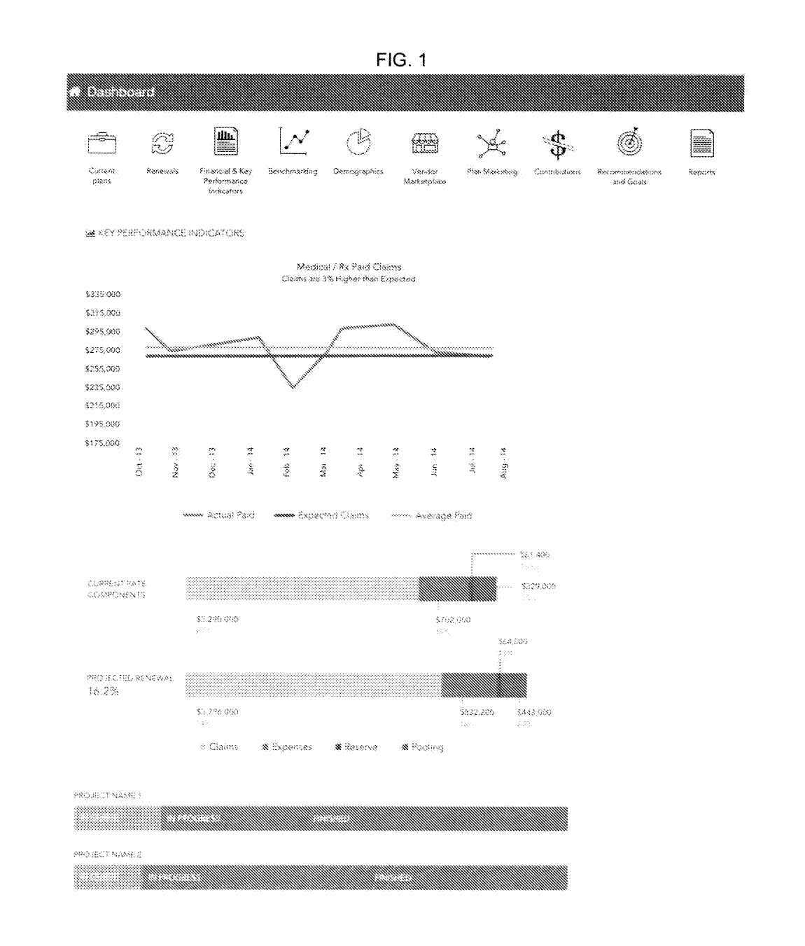

As illustrated in FIG. 1, based on months of incoming insurance claims data, utilizing the renewal underwriting engine, a user can be provided with a projection of a renewal increase. Further, the projected renewal increase can automatically be updated every month. For example, FIG. 1 illustrates that the user has chosen to track monthly claims in a format that compares actual claims/average claims and expected claims. The current rate components of the program and projected renewal increase based on emerging claims data may also be shown as shown near the bottom of FIG. 1. Additional key performance indicators may include tracking compliance in a group member fitness or wellness program, relativity to a healthcare Cadillac Tax, and many other benchmarks. Members of the group may be allowed to access the system by a group member enroller 74 so they may learn automatically about benefit options, enroll in plans, and communicate enrollment to insurers or administrators.

As shown in FIG. 17, insurance interface 78 also is provided. Insurers may be able to predict their new business flows and chance of success for selling to any given group. This kind of prediction is based on a model of past employer or group goals, price sensitivity and plan design needs, and other such factors to determine the likelihood of a piece of business for the insurer with the group.

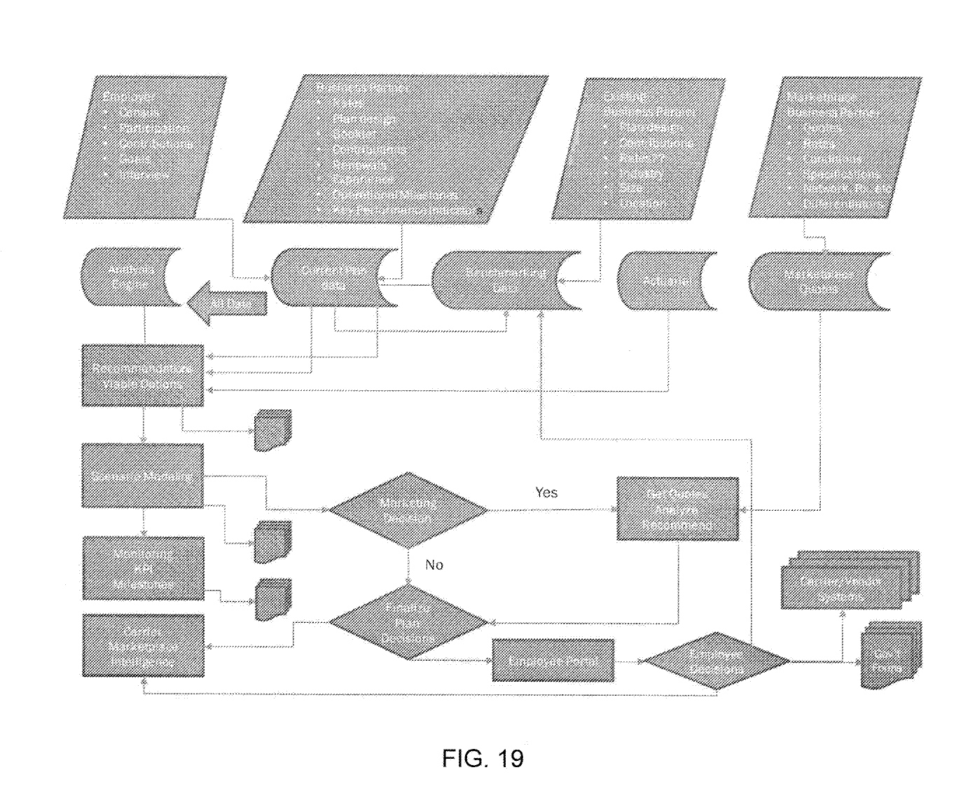

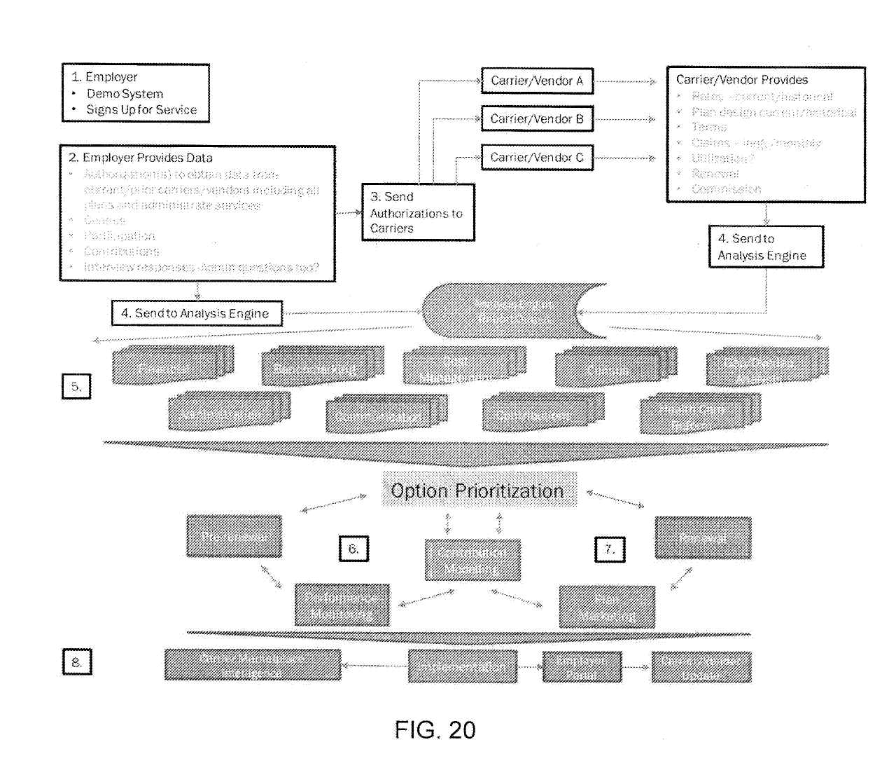

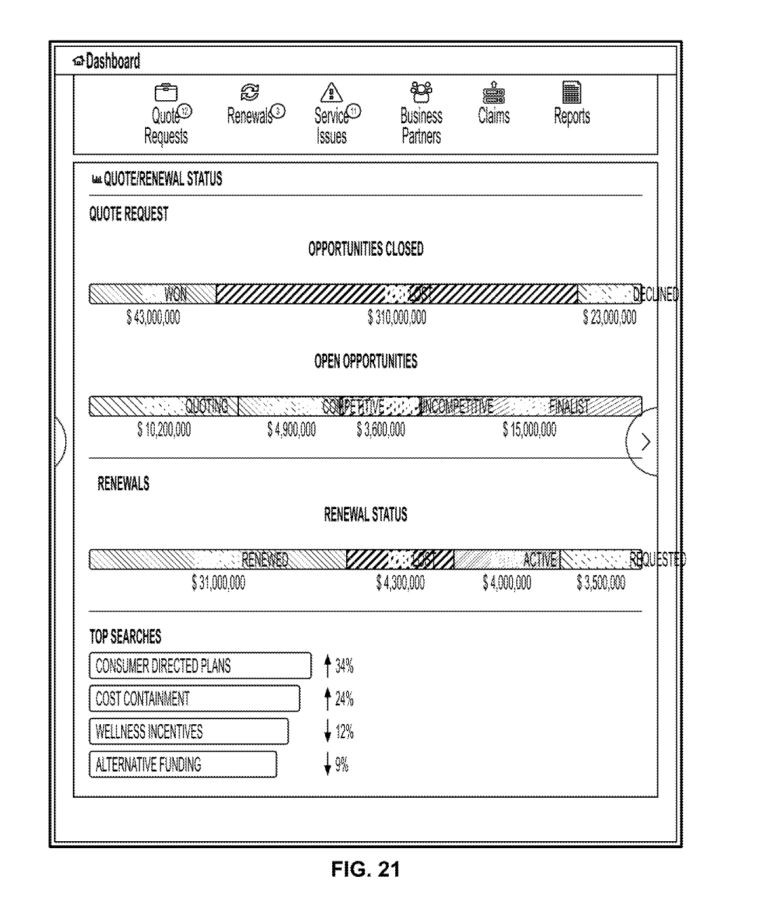

FIGS. 19 and 20 provide an overview, in general terms, of a process flow according to aspects of the present disclosure.

FIG. 19 illustrates a business partner, which may be, for example, an insurance carrier, a service provider, such as a Cobra administrator, or a human resources information system (HRIS) vendor or intermediary, such as a broker or consultant. The business partner may be an outside source of information, vendor, or data that may be provided to modeling engine 50 from another source. A broker business partner may also Cobra administrative services to an employer, and thus, may be functioning as a service provider as well as an intermediary.

FIG. 20 illustrates the sources of information for the modeling analysis performed in section 5. The result of the analysis and modeling may be fed as recommendations to the employer, as illustrated section 6 of FIG. 20. Section 6 illustrates that the impact of implementing various options may be modeled using the modeling tools and functions provided in the modules shown in FIG. 20. Using the scenario modeling tools, an employer can understand and weigh viable options and then prioritize the actions the employer wishes to take for the plan. Multi-sided arrows in FIGS. 19 and 20 underscore the fact that an employer may wish to use this information as part of an iterative process. Various sequences of the functionality provided by modeling engine 50 may be conveniently employed by the user to model and to analyze various plan options and features, and to move back and forth. The results of the processing by one module may impart further options or factors for consideration using the iterative process, and using data that is enhanced, that is data that is sourced from a variety of data collection points, fine-tuned insurance feature may be arrived at. Data for the insured entities, for example, for the employees, may be obtained from a variety of sources, including a current or previous insurance plan or a current or previous set of insurance features, from an employee census or from other company records, from a database of an insurance carrier or an insurance broker from public records, or the like. Such data from more than one source may be collected for or during any given modeling session. Also, such information about employees may be estimated based on known facts about the company or group, such as the industry and geographic location of the company or group, the size of the company or group, the gross earnings or past insurance premiums paid by the company or group, or the like.

After an insurance feature recommendation is generated and provided to a user, benchmark information for the insurance feature may be obtained and provided as feedback for the user. The user may then revise or fine-tune or adjust a metric associated with the insurance feature. For example, a deductible, a coinsurance or a monthly premium amount may be adjusted in response to the benchmark information provided for that insurance aspect. Then, an insurance plan or set of insurance features may be reported and presented based on the revised insurance feature, and this set of insurance features may be the basis for submitting a bid or for soliciting a bid for insurance.

A group, such as an employer, may also wish to provide a metric, such as a dollar amount, a percentage amount, or the like to constrain recommendations for insurance features and, more generally, to constrain the insurance plan or set of insurance features that is ultimately generated. For example, an employer may wish to set a total health insurance budget of a hard number amount, such as a hundred thousand dollars per year for the group, or to set a maximum percentage increase over last year for the group. Or, the employer may wish to increase employee contributions for the year by X % or by a certain dollar amount compared to the previous year. In addition, or in the alternative, an employer may wish to cap each employee's contribution to the lowest premium cost plan or to all plans to a particular percentage number. Many other such group or employer limit values or percentages or other metrics or criteria may be received and provided. According to such group limit data, insurance feature recommendations and the insurance feature set or insurance plan may be limited and constrained to such a limit data.

Also, a plan selected by an employer may be submitted to an insurer or broker or to a marketplace or insurance exchange generally, and a bid may then be provided to the employer. The system may automatically submit such a bid and such a bid may automatically be indicated and accepted if certain criteria are met. The plan submitted by the employer may be a bid or offer, or may be a solicitation for a bid or offer by the insurer, carrier, broker, marketplace or exchange. Bid controller 76 of modeling engine 50 may keep track of plans generated and stored, plans submitted to a broker, plans submitted to an insurer and/or the like, as well as bids received and accepted. In this way, modeling engine 50 may close the loop, serving to allow a group to model, analyze, plan, and receive recommendations for plans, to submit a bid or a request for bid, to receive an acceptance of a bid, and to transmit an acceptance of an offer.

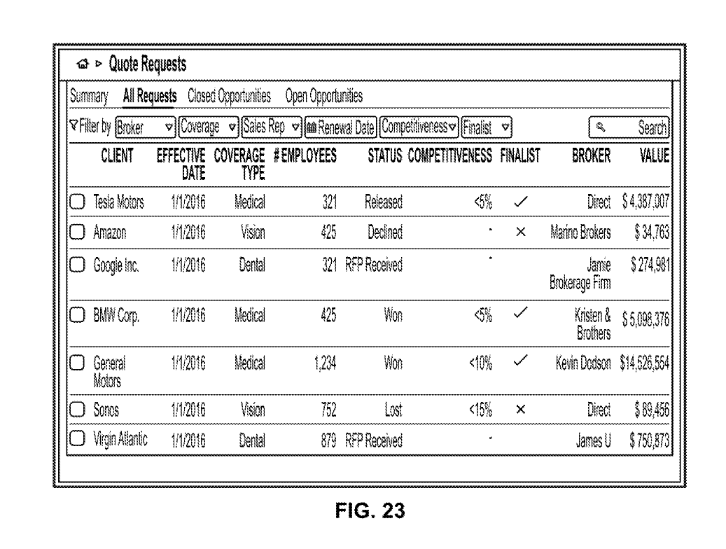

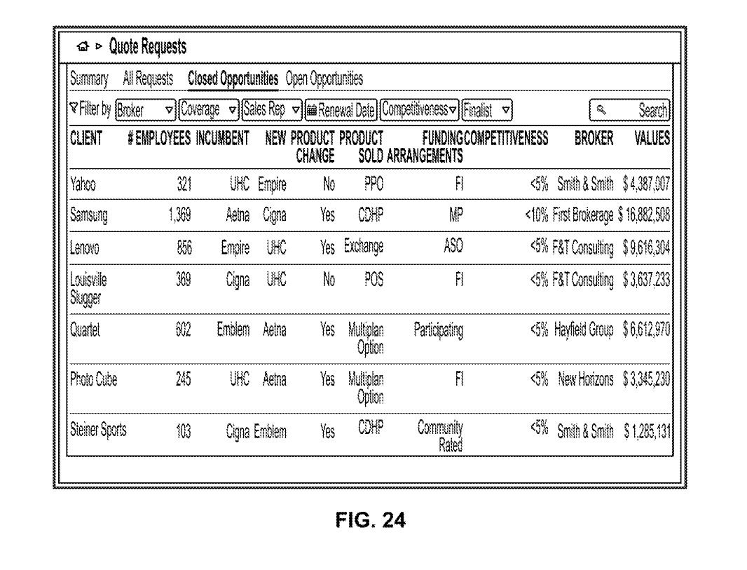

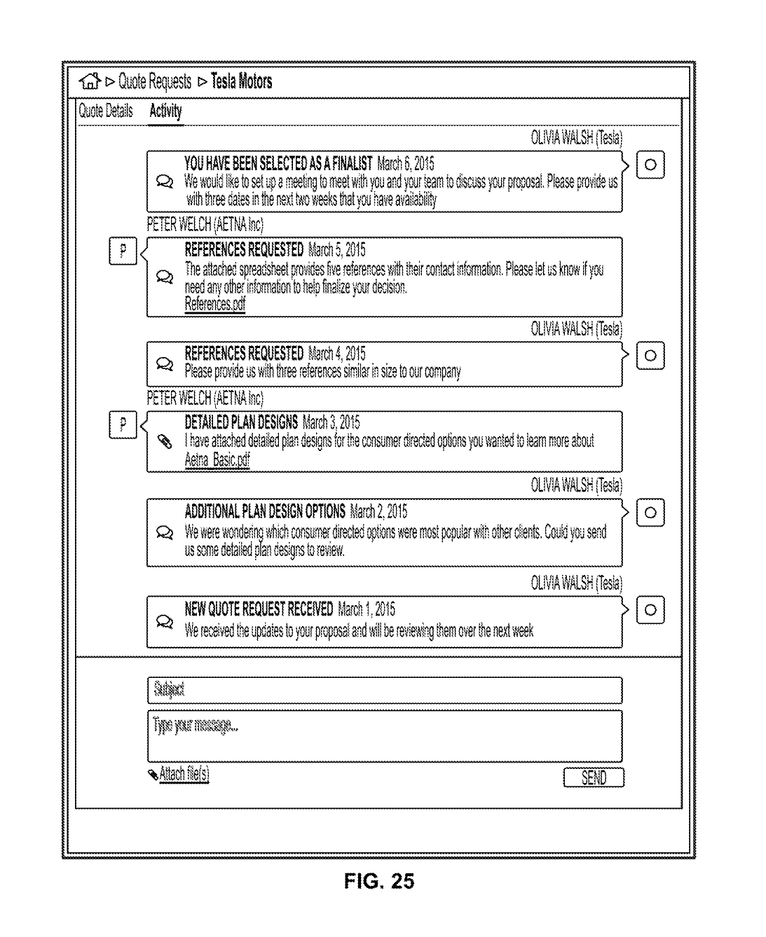

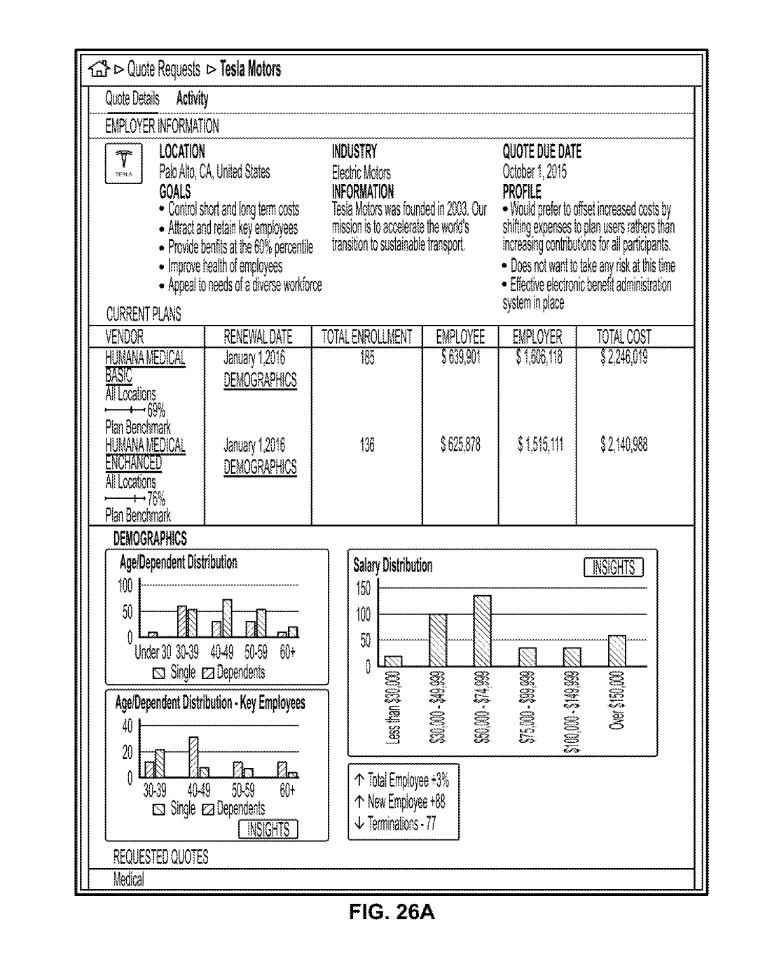

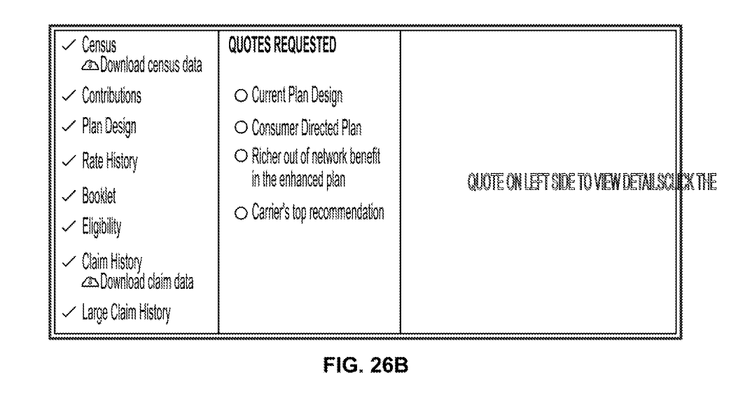

FIGS. 21-26B illustrate a graphical user interface that may be provided to an insurer or carrier to provide an overview and some detail regarding accounts won or lost by the insurer or carrier. FIG. 21 illustrates a dashboard that summarizes and quantifies in dollars lost and won contracts.

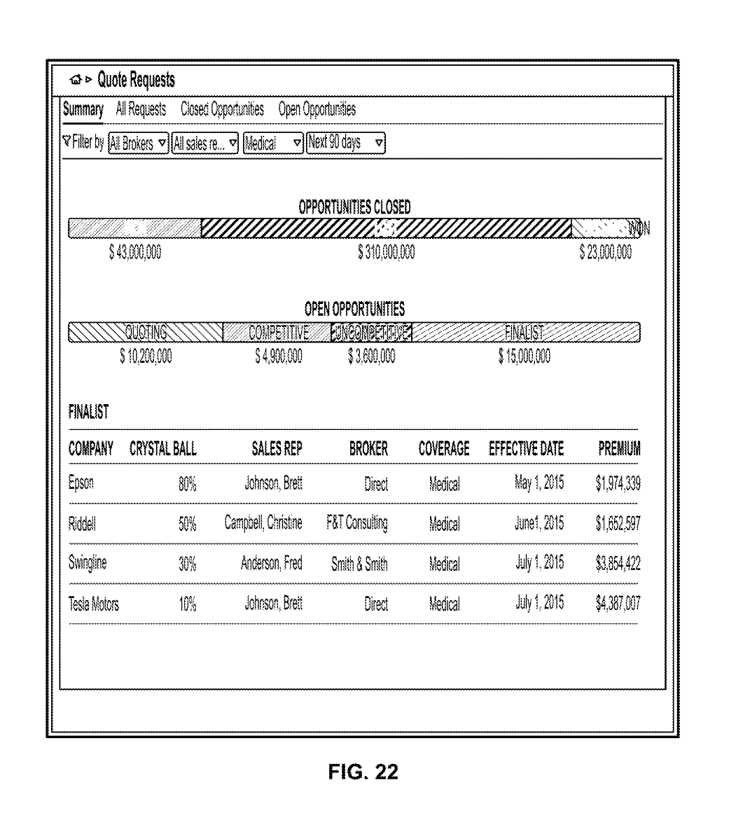

From the dashboard, the user at the insurer or carrier may choose quote requests to obtain information illustrated in FIG. 22, which shows requests for bids received from various employers of the groups. A user may then select all requests to obtain a list of requests received from the listed groups, a user may select quote requests closed opportunities to select to view the list of group plans under this category. By selecting a particular employer or group, in this case the company Tesla Motors, additional information may be gleaned about this group plan, and then the user may wish to drill down to a further level of granularity about this plan or this employer.

In this way, the insurer can get a broad perspective regarding opportunities that were won as well as those that were lost, those that are opened and those that are closed and the relative values of each. Additional patterns of winning and losing bids may be provided and a quick overview of various categories of group plan bids and group plan contracts may be obtained.

The present methods, functions, systems, computer-readable medium product, or the like, including modeling engine 50, may be implemented using hardware, software, firmware or a combination of the foregoing. Further, they may be implemented in one or more computers, computing devices, computer systems or other processing systems, such that no human operation may be necessary. That is, the methods and functions can be performed entirely automatically through machine operations, but need not be entirely performed by machines. A computer or computer systems including modeling engine 50, as described herein, may include one or more processors in one or more units for performing the method and implementing the system according to the present disclosure, located in proximity to one another provided, for example, in a local enterprise setting, or they may be connected via one or more wired or wireless connections via a network, for example, these computers, systems or processors may be located in a cloud or may be or off premises at a third party contractor.

Network interface 51 and other communication interfaces may include a wired or wireless interface communicating over TCP/IP paradigm, for example, using HTTP, or other types of protocols, and may communicate via a wire, cable, fire optics, a telephone line, a cellular link, a radio frequency link, such as WI-FI or Bluetooth, a LAN, a WAN, VPN, or other such communication channels and networks, or via a combination of the foregoing.

Also, modeling engine 50 may be included in or may be provided as part of one or more servers. One or more modules of modeling engine 50 may run or may be provided as part of a device separate from other modules of modeling engine 50.

Accordingly, a method, system, device and the means for providing such a method are described for providing improved modeling, insurance feature visualization, and cost feedback. An improved computer system is thus provided for. Accordingly, a computer system, such as a website, can thus perform better in providing insurance modeling, underwriting scenario visualization, and insurance plan submission and bidding. As a result, a computer tool is provided that requires fewer steps and less time to obtain accurate, detailed insurance plan information providing contrasting insurance feature options and their relatives values based on actuarial data, associated industry benchmarks, and their costs. Less energy may be consumed by the computer system as a result of the fewer number of back and forth communications required, and less wasteful heat may be generated and dissipated.

Although the present invention has been described in relation to particular embodiments thereof, many other variations and modifications and other uses will become apparent to those skilled in the art. Steps and units described in relation to one aspect of the method or system may be added, or substituted, for steps or units described with respect to another aspect of the system. Combinations and permutations of steps different from those outlined are also contemplated. Steps outlined in sequence need not necessarily be performed in sequence, not all steps need necessarily be executed, and other intervening steps may be inserted. It is preferred, therefore, that the present invention be limited not by the specific disclosure herein.

What is claimed is:

1. A data-driven scenario modeling engine comprising an automated data processor and configured to generate at least one insurance feature recommendation for a group comprising a plurality of insured entities, the scenario modeling engine comprising:
an input user interface configured to receive a user response indicating at least one insurance goal for the group;
a demographic data inputer configured to receive automatically demographic data regarding the plurality of insured entities;
an insurance benefit profile generator configured to generate automatically an insurance benefit profile based on the indicated insurance goal and the received demographic data; and
a user interface generator configured to report automatically the at least one insurance feature recommendation for the group based on the generated insurance benefit profile.

2. The scenario modeling engine of claim 1, further comprising:
an insurance plan analyzer configured to receive at least one of an insurance plan and a benefit set of the group,
wherein the insurance benefit profile is based on the received at least one of the insurance plan and the benefit set of the group.

3. The scenario modeling engine of claim 1, further comprising:
a benchmark comparator configured to generate a relevant group benchmark for the at least one insurance feature recommendation based on relevant group data retrieved for the insurance feature,
wherein the user interface generator is configured to report the generated relevant group benchmark for the at least one insurance feature recommendation.

4. The scenario modeling engine of claim 3, wherein the relevant group benchmark is based on an industry of the group.

5. The scenario modeling engine of claim 3, wherein the relevant group benchmark is based on a geographic area of the group.

6. The scenario modeling engine of claim 3, wherein the relevant group benchmark is based on a size of the group.

7. The scenario modeling engine of claim 1, wherein the user interface generator is configured to provide an estimate of at least one of a cost and a value of the at least one insurance feature, and to report in real time a re-estimated cost or value in response to user adjustment of an aspect of the at least one insurance feature.

8. The scenario modeling engine of claim 1, wherein the plurality of insured entities comprises people employed by the group, and the at least one insurance feature comprises an insurance benefit for an entity of the plurality of entities.

9. The scenario modeling engine of claim 1, wherein the modeling engine further comprises a bid controller configured to submit at least one of a bid and a solicitation for a bid for an insurance plan containing the at least one insurance feature to a marketplace or a carrier.

10. The scenario modeling engine of claim 1, wherein the user interface generator is configured to provide an indication of a percentage or a quantity associated with a user input feature, and to facilitate user input for changing the percentage or the quantity associated with the plan underwriting factor.

11. The scenario modeling engine of claim 10, wherein the user interface generator is configured to provide a user input feature configured to facilitate user submission of a plan to a carrier in accordance with the changed percentage or quantity.

12. The scenario modeling engine of claim 1, wherein the user interface generator is configured to provide user input feature configured to facilitate the user's submission of a plan to a carrier.

13. The scenario modeling engine of claim 1, wherein the plurality of insured entities comprises self-insured entities.

14. The scenario modeling engine of claim 1, wherein the user interface generator is configured to provide at least one of a contribution amount and a contribution percentage corresponding to a contribution under an insurance plan comprising an insurance feature comprised in the at least one insurance feature recommendation, and to report in real time a re-estimated cost or value of the insurance plan in response to user adjustment of the least one of the contribution amount and the contribution percentage.

15. The scenario modeling engine of claim 14, wherein the contribution comprises a contribution by an insured entity of the plurality of insured entities.

16. The scenario modeling engine of claim 14, wherein the contribution comprises a contribution by a subset of insured entities of the plurality of insured entities, the subset of insured entities comprising insured entities within a salary range.

17. The scenario modeling engine of claim 1, wherein the user interface generator is configured to provide options under an insurance plan comprising an insurance feature contained in the at least one insurance feature recommendation, the options being available to be chosen by insured entities of the plurality of insured entities, and to receive an input indicating an election of a choice of the options.

18. The scenario modeling engine of claim 1, wherein the user interface generator is configured to provide a quote for an insurance plan for the group in response to a request received from the group, the insurance plan comprising an insurance feature contained in the insurance feature recommendation.

19. The scenario modeling engine of claim 18, wherein the user interface generator is configured to provide a portal to facilitate communication between the group and an originator of the quote.

20. A data-driven scenario modeling engine comprising an automated data processor and configured to generate an enhanced insurance feature recommendation for a group comprising a plurality of insured entities, the scenario modeling engine comprising:
a demographic data aggregator configured to receive demographic data regarding the plurality of insured entities;
a user interface configured to receive a user response indicating at least one insurance goal for the group regarding at least one insurance feature;
an insurance benefit profile generator configured to generate an insurance feature profile based on the indicated insurance goal and the received demographic data;
a recommendation generator configured to generate a first insurance feature recommendation based on the insurance benefit profile;
an industry benchmark data collector configured to receive industry benchmark data for the at least one insurance feature;
a benchmark-based enhancer engine configured to report automatically the first insurance feature recommendation compared with the industry benchmark data for the at least one insurance feature;
the benchmark-based enhancer engine configured to receive a user input indicating revision for the at least one insurance feature; and
the benchmark-based enhancer engine configured to report automatically a set of insurance features based on the revision for the at least one insurance feature.

21. The scenario modeling engine of claim 20, further comprising:
an insurance plan data collector and analyzer configured to receive at least one of an insurance plan and an insurance feature set of the group, and to determine the insurance feature profile based on the at least one of the received at least one of the insurance plan and the insurance feature set of the group.

22. The scenario modeling engine of claim 20, wherein the industry benchmark data is based only on an industry of the group.

23. The scenario modeling engine of claim 20, wherein the industry benchmark data is based on a geographic area of the group.

24. The scenario modeling engine of claim 20, wherein the industry benchmark data is based on a size of the group.

25. The scenario modeling engine of claim 20, wherein the benchmark-based enhancer engine is configured to provide an estimate of at least one of a cost and a value of the at least one insurance feature, and to report in real time a re-estimated cost or value in response to the user revision of the at least one insurance feature.

26. The scenario modeling engine of claim 20, wherein the benchmark-based enhancer engine is configured at least one of automatically to solicit a bid and automatically to provide a bid based on the set of insurance features reported.

27. The scenario modeling engine of claim 20, wherein the demographic data aggregator is configured to receive the demographic data from an employee census.

28. The scenario modeling engine of claim 20, further comprising:
a group limit data receiving module configured to input limit data for the group,
wherein the insurance benefit profile generator is configured constrain the first insurance feature recommendation according to the limit data, and the benchmark-based enhancer engine is configured to constrain the set of insurance features according to the limit data.
